(19) United States
(12) Patent Application Publication
(10) Pub. No.: US 2025/0276471 A1
(43) Pub. Date: Sep. 4, 2025

(54) HOLDER FOR STABILIZING A LINEAR SHAPED CHARGE DURING EPOXY CURING

(71) Applicant: The United States of America, as Represented by the Secretary of the Navy, Crane, IN (US)

(72) Inventors: Samuel C. Long, Bloomington, IN (US); J. Cabot Faultless, Bloomington, IN (US); Thinh G. Hoang, Bloomington, IN (US)

(73) Assignee: The United States of America, as represented by the Secretary of the Navy, Arlington, VA (US)

(21) Appl. No.: 18/819,724

(22) Filed: Aug. 29, 2024

Related U.S. Application Data
(60) Provisional application No. 63/535,143, filed on Aug. 29, 2023.

(51) Int. Cl. B29C 35/00

(52) U.S. Cl. CPC B29C 35/002

(57) ABSTRACT

Disclosed is a holder for stabilizing a linear shaped charge during epoxy curing. The device includes a support with a rectangular midsection having a first and a second end, and a central aperture; a pair of stair-step risers extending down from the first and the second end; and a pair of curved legs extending from the stair-step risers. The pair of curved legs lock the support onto a container. A linear shaped charge is positioned within the central aperture and extends downward into the container where it is stabilized while a curing agent within the container hardens. The support removes the need for constantly checking the alignment of the liner shaped charge while curing and prevents the need for sanding, both of which save considerable time when compared to previous methods. The support is designed with a raised midsection to prevent it from being bonded to the epoxy during the curing process, thereby allowing it to be reused.

### CROSS-REFERENCE TO RELATED APPLICATIONS

The present application claims priority to U.S. Provisional Patent Application Ser. No. 63/535,143, filed Aug. 29, 2023, entitled “LINEAR SHAPED CHARGE SUPPORT FOR EPOXY CURING,” the disclosure of which is expressly incorporated by reference herein.

### STATEMENT REGARDING FEDERALLY SPONSORED RESEARCH OR DEVELOPMENT

The invention described herein includes contributions by one or more employees of the Department of the Navy made in performance of official duties and may be manufactured, used and licensed by or for the United States Government for any governmental purpose without payment of any royalties thereon. This invention (Navy Case 210315) is assigned to the United States Government and is available for licensing for commercial purposes. Licensing and technical inquiries may be directed to the Technology Transfer Office, Naval Surface Warfare Center Crane, email: Cran_T2@navy.mil.

### FIELD OF THE INVENTION

The field of invention relates generally to supports. More particularly, it pertains to linear shaped charge support for epoxy curing.

### BACKGROUND

A linear shaped charge (LSC) is an explosive device with a continuous explosive core enclosed in a chevron or V-shaped metal lining. The lining causes tamping upon detonation, which focuses an explosive high pressure wave as it becomes incident to the side wall causes the metal liner to collapse, which creates cutting force via a continuous, knife-like jet.

Linear shaped charges are potted in a curing agent (epoxy) for quality control, lot acceptance testing, and analysis of its structure. Previous methods for potting require the LSCs to be sanded flat on one end by hand. As can be appreciated, sanding requires a significant amount of time due to the number of samples in a given lot. After sanding, the LSCs are placed upright in a pot with epoxy for curing. Due to the shape of the LSCs, they are prone to falling over while curing. As a result, the LSCs need to be frequently monitored, and their position corrected before the epoxy cures. The process of sanding and potting/curing takes approximately 48 hours. As can be appreciated from the above, a device that can support a linear shaped charge during potting is desirable.

### SUMMARY OF THE INVENTION

Disclosed is a holder for stabilizing a linear shaped charge during epoxy curing. The device includes a support with a rectangular midsection having a first and a second end, and a central aperture; a pair of stair-step risers extending down from the first and the second end; and a pair of curved legs extending from the stair-step risers. The pair of curved legs lock the support onto a container. A linear shaped charge is positioned within the central aperture and extends downward into the container where it is stabilized while a curing agent within the container hardens. The support removes the need for constantly checking the alignment of the liner shaped charge while curing and prevents the need for sanding, both of which save considerable time when compared to previous methods. The support is designed with a raised midsection to prevent it from being bonded to the epoxy during the curing process, thereby allowing it to be reused.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows a perspective view of a linear shaped charge support.

FIG. 2 shows an overhead view of a linear shaped charge support.

FIG. 3 shows a side view of a linear shaped charge support.

FIG. 4 shows a perspective view of a linear shaped charge support supporting a linear shaped charge in a container.

FIG. 5 shows a perspective view of a linear shaped charge support supporting a linear shaped charge in a container.

FIG. 6 shows an overhead view of a linear shaped charge support supporting a linear shaped charge in a container.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Generally, provided is a holder for stabilizing a linear shaped charge during epoxy curing comprising: a support comprising; a rectangular midsection with a first and a second end, and a central aperture; a pair of stair-step risers extending down from the first and the second end; and a pair of curved legs extending from the stair-step risers; wherein the pair of curved legs lock the support onto a container; wherein a linear shaped charge is positioned within the central aperture and extends downward into the container where it is stabilized while a curing agent within the container hardens.

In an illustrative embodiment, the linear shaped charge comprises a chevron or a V-shaped cross-section. In an illustrative embodiment, the container comprises a lip, an open top, a bottom, sidewalls, and a round cross-section. In an illustrative embodiment, the central aperture is chevron or a V-shaped. In an illustrative embodiment, the stair-step risers vertically offset the rectangular midsection from the container to prevent wicking of the curing agent up the linear shaped charge.

In an illustrative embodiment, provided is a holder for stabilizing a linear shaped charge during epoxy curing comprising: a container comprising; a lip, an open top, a bottom, sidewalls, and a round cross-section; and a support comprising; a rectangular midsection with a first and a second end, and a central aperture; a pair of stair-step risers extending down from the first and the second end; and a pair of curved legs extending from the stair-step risers; wherein the pair of curved legs match the round cross-section to permit locking of the support onto the lip of the container; wherein a linear shaped charge is positioned within the central aperture and extends downward into the container where it is stabilized while a curing agent within the container hardens.

In an illustrative embodiment, the linear shaped charge comprises a chevron or a V-shaped cross-section. In an illustrative embodiment, the container comprises a lip, an open top, a bottom, sidewalls, and a round cross-section. In an illustrative embodiment, the central aperture is chevron or a V-shaped. In an illustrative embodiment, the stair-step risers vertically offset the rectangular midsection from the container to prevent wicking of the curing agent up the linear shaped charge.

In an illustrative embodiment, provided is a system for stabilizing a linear shaped charge during epoxy curing comprising: a linear shaped charge; a container comprising; a lip, an open top, a bottom, sidewalls, and a round cross-section; and a support comprising; a rectangular midsection with a first and a second end, and a central aperture; a pair of stair-step risers extending down from the first and the second end; and a pair of curved legs extending from the stair-step risers; wherein the pair of curved legs match the round cross-section to permit locking of the support onto the lip of the container; wherein the linear shaped charge is positioned within the central aperture and extends downward into the container where it is stabilized while a curing agent within the container hardens.

In an illustrative embodiment, the linear shaped charge comprises a chevron or a V-shaped cross-section. In an illustrative embodiment, the central aperture is chevron or a V-shaped. In an illustrative embodiment, the stair-step risers vertically offset the rectangular midsection from the container to prevent wicking of the curing agent up the linear shaped charge.

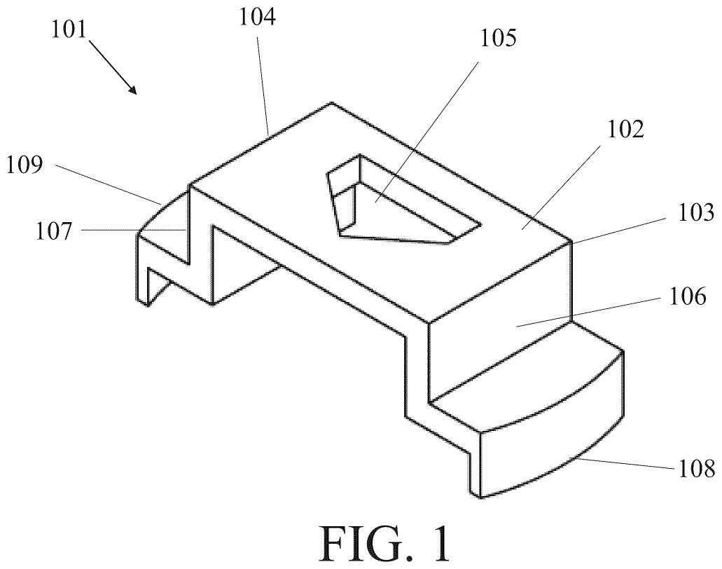

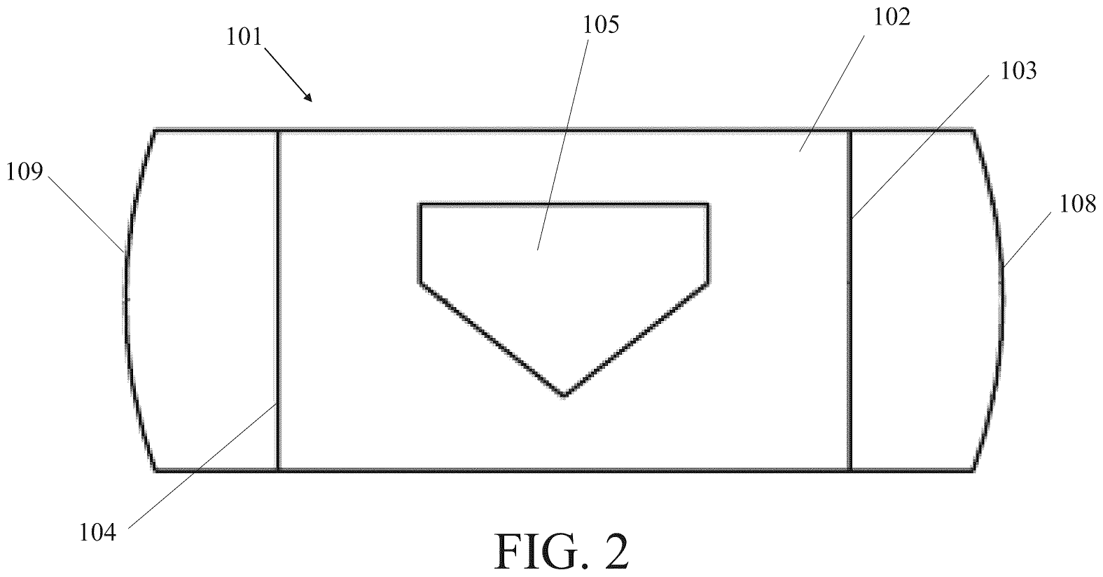

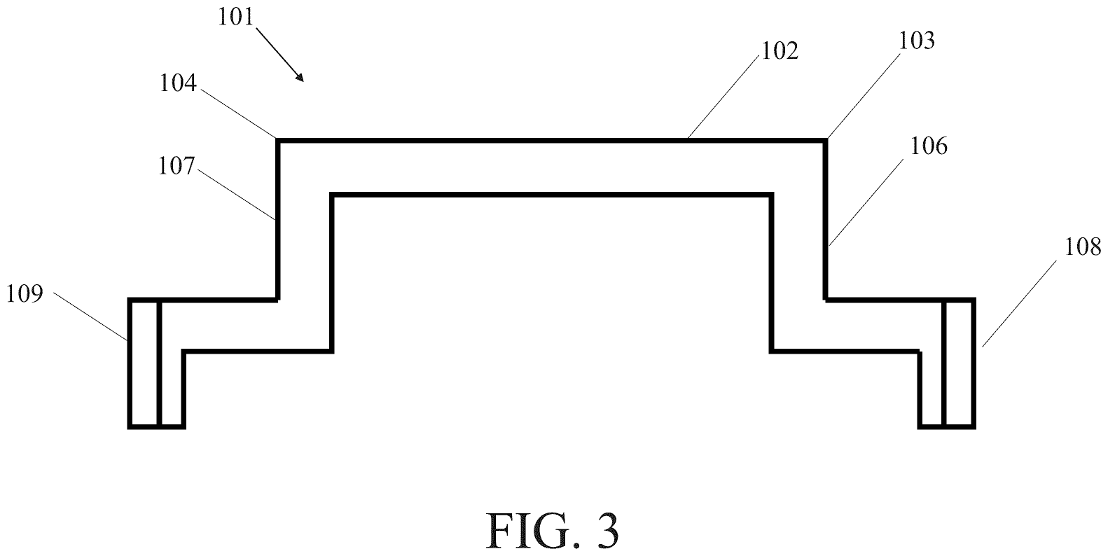

FIG. 1 shows a perspective view of a linear shaped charge support 101, FIG. 2 shows an overhead view of a linear shaped charge support 101, FIG. 3 shows a side view of a linear shaped charge support 101. In an illustrative embodiment, the linear shaped charge support 101 comprises a rectangular midsection 102 with a first and a second end 103, 104, and a central aperture 105; a pair of stair-step risers 106, 107 extending down from the first and second end 103, 104; and a pair of curved legs 108, 109 extending from the stair-step risers 106, 107. In an illustrative embodiment, the pair of curved legs 108, 109 lock the support 101 onto a container (shown below). In an illustrative embodiment, a linear shaped charge (shown below) is positioned within the central aperture 105 and extends downward into the container where it is stabilized while a curing agent within the container hardens. In an illustrative embodiment, the central aperture 105 can be sized and shaped to accommodate a linear shaped charge. In an illustrative embodiment, the central aperture 105 can be chevron or a V-shaped.

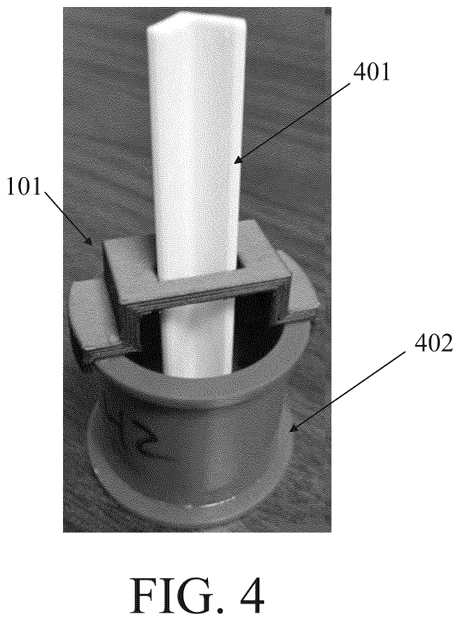

FIG. 4 shows a perspective view of a linear shaped charge support 101 supporting a linear shaped charge 401 in a container 402. In an illustrative embodiment, the linear shaped charge 401 is a conventional linear shaped charge with a continuous explosive core enclosed in a metal lining. In an illustrative embodiment, the linear shaped charge 401 comprises a chevron or a V-shaped cross-section.

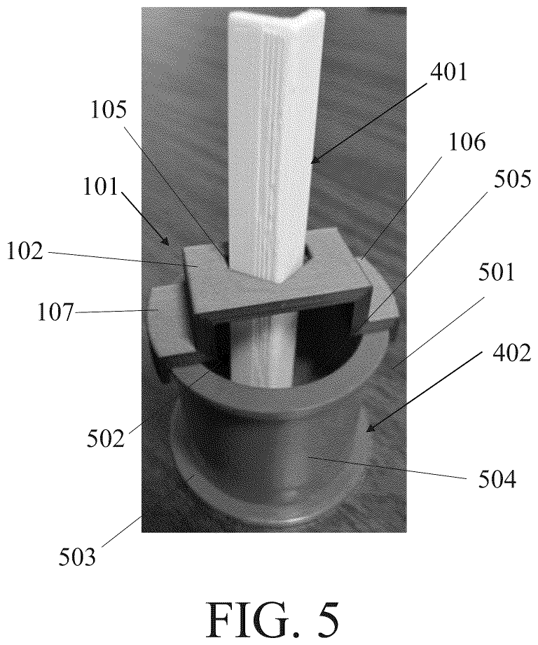

FIG. 5 shows a perspective view of a linear shaped charge support supporting a linear shaped charge 401 in a container 402. In an illustrative embodiment, the pot (container) 402 comprises a lip 501, an open top 502, a bottom 503, sidewalls 504, and a round cross-section 505. In an illustrative embodiment, the stair-step risers 106, 107 vertically offset the rectangular midsection 102 of the support 101 from the lip 501 of the container 402 to prevent wicking of the curing agent (in some embodiments, epoxy) up the sides of the linear shaped charge 401, which can otherwise cause the components (the linear shaped charge 401 and support 101) to fuse together. Testing showed that a non-raised midsection provides the opportunity for significant interaction (wicking of epoxy) between the support 101, the curing agent being used and the linear shaped charge 401. At the center of the support 101 is a rectangular midsection 102 comprising central aperture 105 that is used to stabilize the linear shaped charge 401 during curing. The is linear shaped charge 401 is positioned vertically through the central aperture 105 for curing.

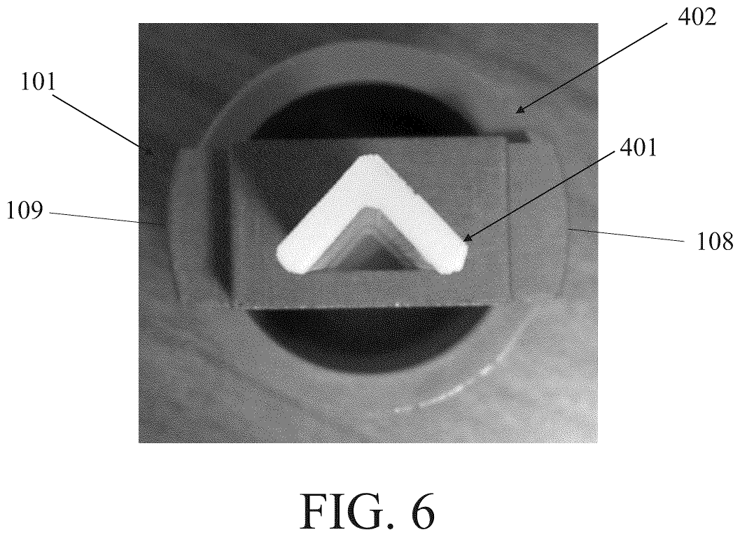

FIG. 6 shows an overhead view of a linear shaped charge support 101 supporting a linear shaped charge 401 in a container 402. In an illustrative embodiment, the pair of curved legs 108, 109 match the round cross-section 505 of the container 402 to permit locking of the support 101 onto the lip 501 of the container 402. In an illustrative embodiment, the container 402 is a small metallurgical pot used for munitions analysis. As can be appreciated, the locking of the curved legs 108, 109 keep the support 101 from moving up and down, and the curved nature of the curved legs 108, 109 prevents the support 101 from changing its orientation aside from rotating about the center axis of the container 402.

To use the device, a support 101 is locked in place on a container 402, and a linear shaped charge 401 is inserted through the central aperture 105 into the container 402 containing a curing medium. The linear shaped charge 401 is placed as vertically as possible, and vertical verification is performed roughly 90 minutes after setting up the process to ensure proper orientation of the linear shaped charge 401 during curing. The timing for the check may vary slightly depending on environmental effects to curing time, such as humidity or temperature. After the material has cured, the support 101 is removed from the top of the container 402 and kept for future use.

Use of the inventive support compared to previous methods removes the need for one end of the linear shaped charge to be sanded, saving more than three hours of labor per linear shaped charge lot. Additionally, the curing epoxy needs to be checked only once, which is far less than the multitude of checks required without the support. The support is designed not to bond to the epoxy during the curing process, thereby allowing it to be reused.

In an illustrative embodiment, the support can be used to hold a variety of items for vertical metallurgical potting in different substances, through the change of the geometry of the central aperture. In an illustrative embodiment, the inventive support can be used to hold a linear shaped charge upright in acid to etch a sheath for grain structure analysis.

Although the invention has been described in detail with reference to certain preferred embodiments, variations and modifications exist within the spirit and scope of the invention as described and defined in the following claims.

1. A holder for stabilizing a linear shaped charge during epoxy curing comprising:
a support comprising;
a rectangular midsection with a first and a second end, and a central aperture;
a pair of stair-step risers extending down from said first and said second end; and
a pair of curved legs extending from said stair-step risers;
wherein said pair of curved legs lock said support onto a container;
wherein a linear shaped charge is positioned within said central aperture and extends downward into said container where it is stabilized while a curing agent within said container hardens.

2. The device of claim 1, wherein said linear shaped charge comprises a chevron or a V-shaped cross-section.

3. The device of claim 1, wherein said container comprises a lip, an open top, a bottom, sidewalls, and a round cross-section.

4. The device of claim 1, wherein said central aperture is chevron or a V-shaped.

5. The device of claim 1, wherein said stair-step risers vertically offset said rectangular midsection from said container to prevent wicking of said curing agent up said linear shaped charge.

6. A holder for stabilizing a linear shaped charge during epoxy curing comprising:
a container comprising;
a lip, an open top, a bottom, sidewalls, and a round cross-section; and
a support comprising;
a rectangular midsection with a first and a second end, and a central aperture;
a pair of stair-step risers extending down from said first and said second end; and
a pair of curved legs extending from said stair-step risers;
wherein said pair of curved legs match said round cross-section to permit locking of said support onto said lip of said container;
wherein a linear shaped charge is positioned within said central aperture and extends downward into said container where it is stabilized while a curing agent within said container hardens.

7. The device of claim 5, wherein said linear shaped charge comprises a chevron or a V-shaped cross-section.

8. The device of claim 5, wherein said container comprises a lip, an open top, a bottom, sidewalls, and a round cross-section.

9. The device of claim 5, wherein said central aperture is chevron or a V-shaped.

10. The device of claim 5, wherein said stair-step risers vertically offset said rectangular midsection from said container to prevent wicking of said curing agent up said linear shaped charge.

11. A system for stabilizing a linear shaped charge during epoxy curing comprising:
a linear shaped charge;
a container comprising;
a lip, an open top, a bottom, sidewalls, and a round cross-section; and
a support comprising;
a rectangular midsection with a first and a second end, and a central aperture;
a pair of stair-step risers extending down from said first and said second end; and
a pair of curved legs extending from said stair-step risers;
wherein said pair of curved legs match said round cross-section to permit locking of said support onto said lip of said container;
wherein said linear shaped charge is positioned within said central aperture and extends downward into said container where it is stabilized while a curing agent within said container hardens.

12. The device of claim 10, wherein said linear shaped charge comprises a chevron or a V-shaped cross-section.

13. The device of claim 10, wherein said central aperture is chevron or a V-shaped.

14. The device of claim 10, wherein said stair-step risers vertically offset said rectangular midsection from said container to prevent wicking of said curing agent up said linear shaped charge.
